(19) United States
(12) Patent Application Publication
(10) Pub. No.: US 2012/0060712 A1
(43) Pub. Date: Mar. 15, 2012

(54) METHOD FOR SETTING THE INKING IN PRINTING PRESSES

(75) Inventors: HOLGER DICK, WIESLOCH (DE); STEPHAN EHRHARDT, NEULUSSHEIM (DE); PETER ELTER, MUHLHAUSEN (DE); PETER FALKNER, HOFFENHEIM (DE); VOLKHARD FRANKE, SCHRIESHEIM (DE); MARTIN KAUFMANN, HEIDELBERG (DE)

(73) Assignee: HEIDELBERGER DRUCKMASCHINEN AG, HEIDELBERG (DE)

(21) Appl. No.: 13/229,856

(22) Filed: Sep. 12, 2011

(30) Foreign Application Priority Data
Sep. 10, 2010 (DE) 10 2010 044 962.8

(51) Int. Cl. B41F 33/00

(52) U.S. Cl. 101/483

(57) ABSTRACT

A method for controlling the inking in printing presses having at least one control computer and at least one printing unit with an inking unit and a dampening unit, includes carrying out settings for controlling the inking in the inking unit and/or dampening unit of the printing press through the use of the control computer. The settings are displayed on a display device and the settings that are carried out are recorded and stored periodically by the control computer.

### CROSS-REFERENCE TO RELATED APPLICATION

This application claims the priority, under 35 U.S.C. §119, of German Patent Application DE 10 2010 044 962.8, filed Sep. 10, 2010; the prior application is herewith incorporated by reference in its entirety.

### BACKGROUND OF THE INVENTION

### Field of the Invention

The present invention relates to a method for controlling the inking in printing presses having at least one control computer and at least one printing unit with an inking unit and a dampening unit.

The control and regulation of the inking in printing presses is a very complex matter, since there are many factors and setting parameters which influence the inking in printing presses. That large number of possible settings and influences on the inking in printing presses make it more difficult for the operator of the printing press to perform the correct setting of the desired inking in order to be able to reproduce the printing original in original form. For that reason, in recent years numerous attempts have been made to largely automate the setting operations in printing presses, in order to avoid erroneous settings by the printer.

An approach of that type emerges from German Published Patent Application DE 10 2005 001 417 A1, corresponding to U.S. Pat. No. 7,860,587, which has the aim of achieving the greatest possible automation of the operation in printing presses. In that case, control software which itself uses data from a print job to calculate all of the setting parameters for the printing operation as far as possible is provided for the control computer of the printing press. To that end, the control computer not only accesses the data from the print job that is just to be processed but, in addition, also calculates setting data which are necessary for setting up and processing the current print job and cannot be derived directly from the data from the current print job from data from similar print jobs in the past and, in addition, takes the general machine history into account. Amongst other things, the machine history makes it possible to determine deviations that occur again and again, which occur because of the specific properties of the printing press being used and therefore, when setting up a new print job, have to be incorporated and taken into account again and again. Those prior art documents also reveal the possibility of simulating settings which have effects on the inking of a printed sheet through the use of a computer and, through the use of a projection device, projecting those settings onto a printed sheet, in order to simulate the changes in the inking on the printed sheet in that way which are caused by changing the inking settings. If the operator does not like those inking settings, then he or she can change them again without difficulty without having to make a proof. In that way, the operator can arrange for the effect of changes on the inking to be visualized optically without actually having to transfer the settings to the inking unit in the printing unit of a printing press and having to produce corresponding proofs.

U.S. Pat. No. 7,345,777 shows a printer which stores aborted or deleted print jobs, so that they can be retrieved again and executed later. Through the use of an operator interface, the user can thus retrieve previously deleted print jobs again and execute them later. To that end, the printer does not completely erase deleted and aborted print jobs but stores them in a print job storage area. The jobs can be retrieved again from that storage area later by the user.

### SUMMARY OF THE INVENTION

It is accordingly an object of the invention to provide a method for controlling the inking in printing presses, which overcomes the hereinafore-mentioned disadvantages of the heretofore-known methods of this general type and which makes it easier for users of a printing press to carry out inking settings for the inking in printing presses.

With the foregoing and other objects in view there is provided, in accordance with the invention, a method for controlling the inking in printing presses that is suitable, in particular, for offset printing presses which, in each printing unit, have an inking unit and a dampening unit, that determine the inking in the respective printing unit. Provision is made for at least the inking and dampening unit in the printing units of the printing press with their control components to be connected to a control computer, so that the control computer is able to perform adjustment operations at least in the inking units and dampening units in order to change the inking settings. To this end, the control computer is able to send actuating commands to actuating drives, such as the motors for adjusting the inking zone openings in a zonal inking unit or the rotational speed regulation of the ductor for regulating the ink supply from the ink fountain. These setting values can be calculated by the control computer itself, as in the prior art, from data from the present print job and by taking earlier print jobs into account, or the setting values can be entered manually by the printer through an operating element such as a touch screen, a mouse or a keyboard on the control desk of the printing press.

The settings for the inking unit and dampening unit calculated by the control computer or the settings entered manually by the printer are themselves displayed on a display device such as a monitor or else the touch screen used to enter the setting values. According to the invention, provision is now made for the settings calculated by the control computer or entered manually by the printer, which settings are then carried out on the inking unit and dampening unit by the control computer, to be recorded and stored periodically by the control computer. This has the great advantage that setting values are stored at regular short time intervals, so that the changes in the setting values which are made during a print job are stored and are also available later to be retrieved repeatedly during the running job. In the prior art, only settings at the start of a print job are calculated and those settings are then made by the control computer. However, no periodic recording and storage is carried out of settings which are changed during a print job, so that the printer in the prior art has no access to setting values that are changed during a job.

In accordance with a first refinement of the invention, provision is made for the recording of the settings by the control computer to be triggered by entering the data of a new print job. When the printer enters a new print job on the control computer of the printing press or selects a corresponding new impending print job through a monitor menu, this constitutes a signal which triggers the periodic recording and storage operation of settings for the inking unit and dampening unit or other components of the printing press. Provision is preferably made for the recording and storage of settings to be carried out whenever settings for the inking unit and dampening unit are changed. As long as the settings remain unchanged, no setting values need to be recorded and stored, so that the accumulation of unnecessary data is avoided and storage space is saved.

In accordance with another refinement of the present invention, provision is made for inking settings which are entered during the processing of a print job or are made by the control computer to be stored in the control computer in a time-clustered manner. Time-clustering is to be understood to mean the joining together over time of individual adjustment operations which proceed chronologically after one another, at one adjustment time. For instance, if the printing press is at a standstill over a certain time period, then the adjustments carried out one after another during the machine stoppage time are combined into a single adjustment at one time. If an inking zone is adjusted repeatedly during the standstill, then only the last value set before the next production printing is stored. Likewise, adjustment operations can be combined in order to track the inking on the basis of the measured color values from a color measuring instrument at one adjustment time, even if they are actually carried out at different times. In this way, the quantity of data can be reduced and there exist few defined times with combined adjustment operations, which the printer can retrieve again later. This makes the matter clearer for the printer.

In accordance with a further particularly advantageous refinement of the invention, provision is made for the variation over time of the inking settings to be displayed on the display device. In this case, all of the inking settings during a print job are displayed, preferably at the clustered times, in a monitor menu on the display device, so that the printer can comprehend the variation over time of the changes in the inking settings at any time and can thus follow how the setting values have changed.

In accordance with an added refinement of the invention, in addition to the inking settings, provision is further made for measured color values or variables influencing the inking settings indirectly to be displayed on the display device. In this case, it is possible to display, one above another on a common time axis, the inking settings and also the measured color values determined at the respective time of the inking setting or other variables influencing the inking setting, such as a quantity of dampening solution. In this way, the printer optically automatically has the correct time reference for inking settings, measured color values and variables influencing the inking settings. In this way, the printer is better able to understand and comprehend the adjustment operations in the inking unit and dampening unit of the printing press.

In accordance with an additional refinement of the invention, provision is made for a selection of preceding inking settings to be possible through the use of an operating element. The operator is thus able to retrieve inking settings lying further back in time without difficulty and to use these instead of the current inking settings through the use of a keyboard, a mouse or a touch screen. This function is normally also designated an undo function, since the operator discards the current setting and instead selects a preceding setting. Nevertheless, the current inking setting is not deleted, so that the operator can likewise fall back on the current inking setting again if the selection of preceding inking settings does not appeal to him or her.

In accordance with again another refinement of the invention, advantageously, provision is additionally made during the entry of changed inking settings for the change in the inking settings relative to the current inking settings to be displayed on the display device. In this case, the current inking settings and the changed inking settings are disposed one above another on a time axis, so that the printer can immediately see the differences between the current inking setting and the changed inking settings. In addition, it is possible to display only the difference between the current inking setting and changed inking settings on the time axis, so that the printer can see at a glance the differences between the current inking setting and changed inking setting and thus estimate whether large or small changes are present.

In accordance with again a further embodiment of the invention, provision is made for the control computer to combine inking zone and ductor adjustments in the inking unit of a printing unit of the printing press into a single adjustment operation. This represents a particular embodiment of the time clustering during adjustment in the inking unit of a printing unit. In this way, it is in particular possible to have the adjustment operations from a plurality of printing units displayed since, as a result of the clustering for each printing unit, only one adjustment operation is displayed, which serves for clarity.

In accordance with again an added embodiment of the invention, provision is further made for measured values on printing materials to be determined through the use of a color measuring instrument during the printing operation and for the control computer to make inking adjustments on the basis of the measured color values being determined in order to compensate for deviations between the measured color values being determined and a printing original, and for these inking adjustments to be combined at one adjustment time when stored by the control computer. This embodiment takes as its basis the conventional procedure in inking regulation, in which, through the use of an in-line color measuring instrument fitted in the printing press or an online color measuring instrument present outside the printing press on a color measuring table, measured values are determined on printing materials, at least at specific time intervals, so that the control computer detects and controls out deviations on the basis of these measured values as compared with the printing original. The adjustments in the printing press that are necessary for the control operation, in particular in the inking unit and dampening unit, are combined at one adjustment time, even if they are executed shortly one after another in practice. In this way, the adjustment operations can be assigned unambiguously to a changed inking setting on the basis of a deviation determined between the printing original and the measured color values.

In accordance with a concomitant embodiment of the invention, provision is further made for a time-clustered curve of the average of all of the inking zones in the inking unit of a printing unit of the printing press to be displayed on the display device, following selection of this printing unit. In this case, the printer is able to select the color from that printing unit which is of interest to him or her, and he or she is not given in displayed form a setting value for each inking zone. Instead, an average of all of the settings of all of the inking zones is generated and then displayed in a clustered manner on the monitor. Thus, for each color and/or each printing unit, the printer is able to see one curve instead of many curves for all of the inking zones in a printing unit, which, in the case of a printing press having eight printing units and 32 inking zones in each case and an ink ductor as an actuating element, would lead to 264 curves, the displaying of which would end in a completely incomprehensible representation.

Other features which are considered as characteristic for the invention are set forth in the appended claims.

Although the invention is illustrated and described herein as embodied in a method for setting the inking in printing presses, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, elevational view of a control desk and a printing unit of a printing press;

FIG. 2 is an elevational view of a monitor view according to the invention;

FIG. 3 is a diagram illustrating a first method for clustering inking settings;

FIG. 4 is a diagram illustrating a second method for clustering inking settings; and

FIG. 5 is a diagram illustrating a third method for clustering inking settings.

### DETAILED DESCRIPTION OF THE INVENTION

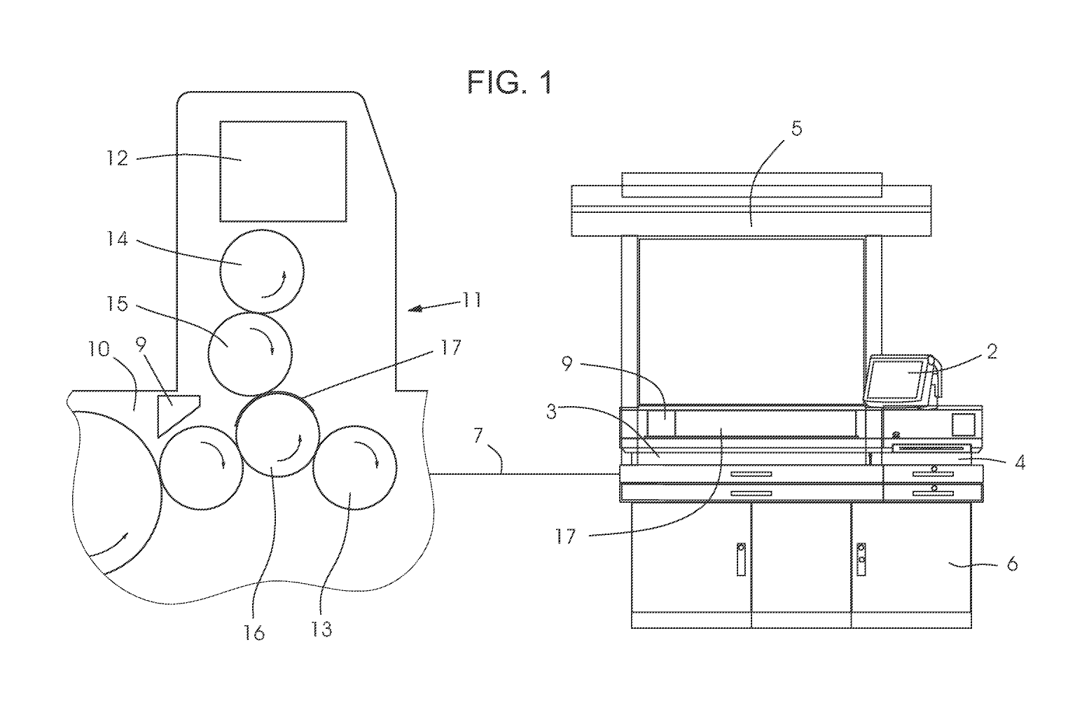

Referring now to the figures of the drawings in detail and first, particularly, to FIG. 1 thereof, there is seen a diagrammatic illustration of a printing unit 10 of a sheet-fed offset printing press 11, in which the printing press 11 is connected through a communications link 7 to a control desk. The control desk includes a lower cabinet 6, in which a control computer 4, that can be operated by a touch screen 2, is disposed. Furthermore, the control desk has a sheet support surface 3, on which printed sheets 17 produced in the printing press 11 can be put down. The printed sheets 17 which are put down on this sheet support surface 3 can be measured through the use of an online color measuring instrument 9, so that measured color values are then passed on to the control computer 4. Disposed above the sheet support surface 3 is a source of illumination 5, which illuminates a printed sheet 17 resting there with standardized light, so that comparable lighting conditions always prevail. The control computer 4 compares the measured color values from the color measuring instrument 9 with image data from a printing original and, in the event of deviations between the measured color values and the printing original, calculates appropriate adjustment commands to control out the deviation. These adjustment commands are sent by the control computer 4 over the communications link 7 to the respective printing unit 10 of the printing press 11, where the adjustment commands are converted into appropriate adjustments through the use of non-illustrated adjusting motors, in an inking unit and dampening unit 12, which may be separate units. Instead of the online color measuring instrument 9 above the sheet support surface 3, the measured color values from a color measuring instrument 9 disposed in the printing press 11 in the form of an in-line color measuring instrument can also be passed on to the control computer 4. In this case, too, the control computer 4 performs a comparison between measured color values and printing original and, if appropriate, controls out deviations. In addition to the inking unit and dampening unit 12, each printing unit 10 has a plate cylinder 14 with a printing plate and a blanket cylinder 15 for transferring the ink from the plate cylinder 14 to the printed sheet 17. During the printing operation, the printed sheet 17 is guided in a press nip between the blanket cylinder 15 and an impression cylinder 16. The printed sheets 17 are guided through the use of transport cylinders 13 between the printing units 10.

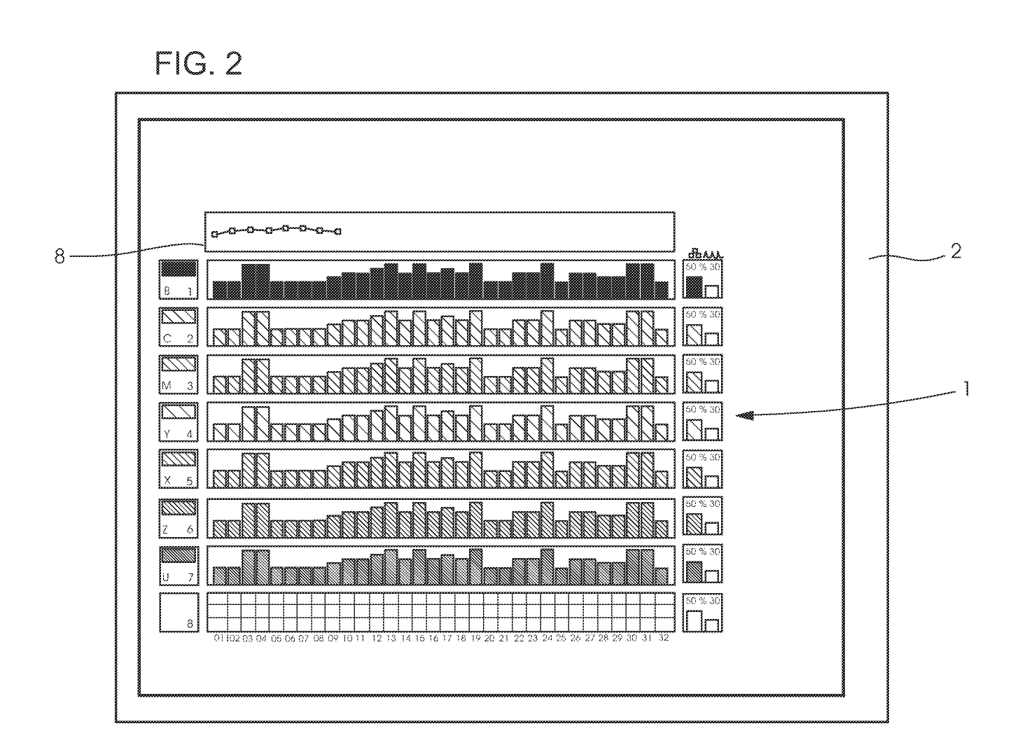

FIG. 2 shows a monitor mask 1 according to the invention, which is displayed on the touch screen 2. In this case, the inking zone setting values for each inking unit 12 in the printing units 10 are disposed one above another, so that the printer is able to see the inking zone setting values for all eight printing units 10 at a glance. In addition, above the inking zone display there is disposed a display area which displays the average of all of the inking zones 8 from a selected printing unit 10. The printer therefore selects one of the eight printing units 10 and can then arrange for the average of the settings of all of the inking zones 8 from the selected printing unit 10 with its variation over time to be displayed on the touch screen 2. Thus, the printer can see at a glance whether or not there are large changes in the settings over time and how the trend of these changes in the settings appears. Each point represents a change time of the printing unit 10 currently selected, with the change time being the time of the clustered inking zone setting. If, then, the printer does not like the current inking settings, he or she can go back through the use of the touch screen 2 or a mouse to a time in the display area of the averages 8 having an inking setting which he or she prefers. When he or she has selected and confirmed this time, the settings for all of the inking zones of the selected printing unit 10 are set to the values which were set at the selected time. However, this is only possible since the control computer 4 stores at least the time-clustered adjustment operations during a print job and thus makes them retrievable again at any time, as is the case in the present invention.

Advantageously, inking adjustments for inking zones and an ink ductor in the inking unit 12 are stored automatically in a job-based manner, i.e. without any intervention of the printer, for a history/undo function. A change of job is defined by the acceptance of a new job or by the performance of a printing plate change. Since, however, even job-based storage/visualization of each individual inking adjustment can lead to a flood of data, data reduction is necessary since there are very many inking actuating elements. For example, in the case of an 8 unit machine with 32 inking zones there are (8 units*(32 inking zones+1 ink ductor))=264 setting variables, which can change independently of one another. In this case, time-cascaded but associated individual adjustments are clustered in a suitable way to form one adjustment. The following is possible:
Inking zone and ductor adjustments during a machine stoppage are combined into a single adjustment. If an inking zone is adjusted repeatedly during the stoppage, then only the last value set before the next production printing is stored.
Tracking values from an online measuring instrument 9 are combined at one adjustment time, even if they become ready at different times.
All of the inking zone and ductor adjustments in the background or during an automated sequence are not stored. These include:
   Color Booster adjustments
   Speed compensations
   AFK inking zone runs
   Ink input profiles
Automatic tracking values from an in-line measuring instrument 9, such as a Heidelberg Inpress Control system, as well as manual adjustments during production printing, can be highly cascaded over time and, furthermore, can occur with an offset from printing unit to printing unit. The following methods will be explained by using the example of a printing press 11 having three printing units 10.

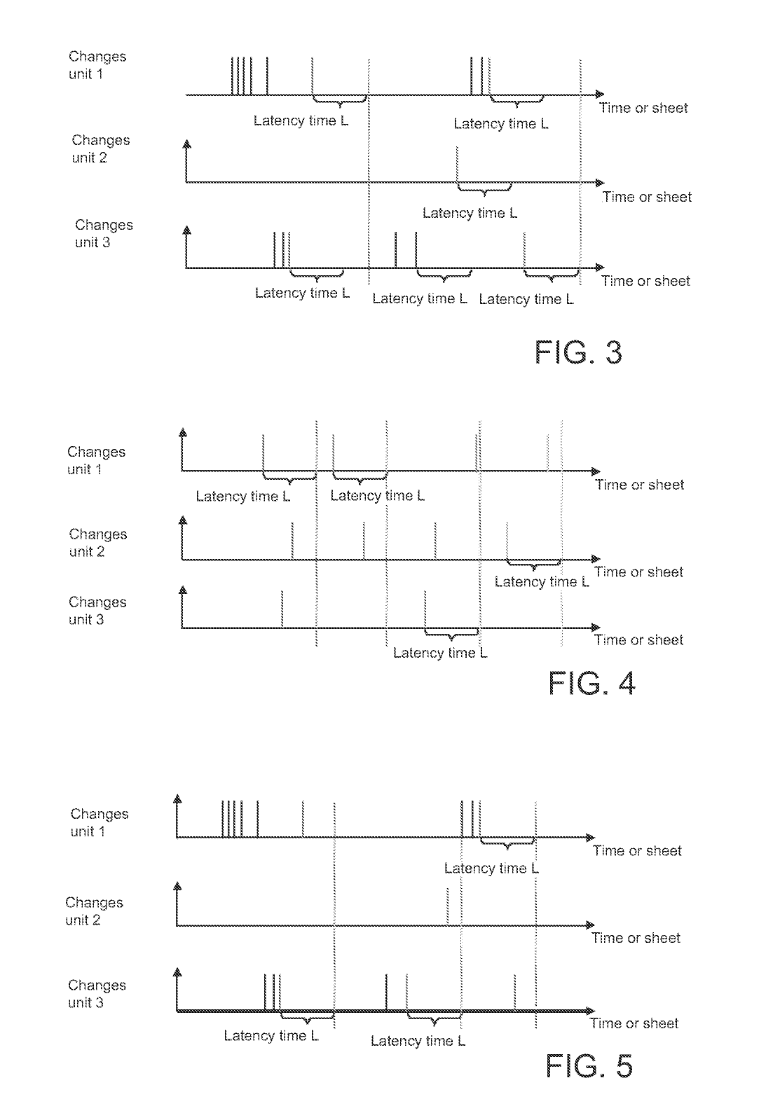

In a first method for the time clustering of adjustments according to FIG. 3, the following is provided:

Each inking change per printing unit 10 must remain stable for a latency time L. When all three printing units are stable and exhibit no new changes, these adjustments are combined into one adjustment—at the time of the last adjustment.

In FIG. 3, at the top, in a first printing unit 1, a plurality of inking zones are adjusted repeatedly. Then, in a third printing unit 3, a plurality of inking zones are adjusted. An adjustment is then made again in unit 1. After that, all of the units remain stable for at least the latency time L, as seen by a dashed line. Consequently, the last adjustments are combined into one adjustment. All of the other adjustments previously are not stored.

The clustering is, however, quite coarse, which means that desired data is possibly also lost, as can be seen from unit 3.

The latency time can be set to a fixed value, e.g. 20 seconds or 50 sheets, since tracking generally lasts for about 100 sheets. However, the time could also be adapted dynamically, depending on the situation.

In the case of the automatic tracking of an in-line measuring instrument 9, a Heidelberg Inpress Control system, or in the event of specific operating actions, steady state conditions in all of the printing units 10 will never or seldom be reached with the first method, and many adjustments will be lost.

In a second method for the time clustering of adjustments according to FIG. 4, the following is therefore provided:

Following the first adjustment in any desired unit, there is a wait for the latency time L in only this unit. After this unit has stabilized, the last adjustments of the other units are consulted in relation to this adjustment, irrespective of whether the latter have complied with the latency time or not. After that, there is a wait for the latency time for the next change.

The latency time should be reduced if the method does not become stable.

FIG. 5 likewise shows the second method but applied to the adjustment operations in the example relating to the first method shown in FIG. 3.

In a third variant, a fixed or random time base is used. It is also possible to combine all three aforementioned methods with one another.

1. A method for controlling inking in printing presses having at least one control computer and at least one printing unit with an inking unit and a dampening unit, the method comprising the following steps:
carrying out settings, with the control computer, for controlling the inking in at least one of the inking unit or the dampening unit of the printing press;
displaying the settings on a display device; and
periodically recording and storing the carried out settings with the control computer.

2. The method according to claim 1, which further comprises triggering the recording of the settings by the control computer by entering data of a new print job.

3. The method according to claim 1, which further comprises storing inking settings being entered during processing of a print job or being made by the control computer in the control computer in a time-clustered manner.

4. The method according to claim 1, which further comprises displaying, on the display device, a variation over time of the inking settings.

5. The method according to claim 4, which further comprises displaying, on the display device, measured color values or variables indirectly influencing the inking setting, in addition to displaying the inking settings.

6. The method according to claim 1, which further comprises selecting preceding inking settings with an operating element.

7. The method according to claim 1, which further comprises displaying, on the display device, changes in the inking settings relative to current inking settings, during an entry of changed inking settings.

8. The method according to claim 1, which further comprises combining inking zone and ductor adjustments in the inking unit of a printing unit of the printing press into a single adjustment operation with the control computer.

9. The method according to claim 1, which further comprises:
determining measured values on printing materials with a color measuring instrument during a printing operation;
making inking adjustments with the control computer based on the determined measured color values to compensate for deviations between the determined measured color values and a printing original; and
combining the inking adjustments at one adjustment time when stored by the control computer.

10. The method according to claim 1, which further comprises displaying a time-clustered curve of an average of all inking zones in the inking unit of a printing unit of the printing press on the display device, following a selection of the printing unit.
